(19) United States
(12) Patent Application Publication
(10) Pub. No.: US 2026/0349643 A1
(43) Pub. Date: Nov. 5, 2026

(54) DYNAMIC ATTRIBUTION ASSIGNMENTS BASED ON EYE-GAZE DIRECTION OF AN INTERPRETER REPRESENTING MULTIPLE USERS

(71) Applicant: MICROSOFT TECHNOLOGY LICENSING, LLC, Redmond, WA (US)

(72) Inventor: Christopher M. SANO, Seattle, WA (US)

(21) Appl. No.: 19/195,463

(22) Filed: Apr. 30, 2025

(51) Int. Cl. G06F 3/14; G06F 3/01; G06T 11/00; G06T 13/40; G06T 13/80; G06V 20/40; G06V 40/20; H04L 12/18

(52) U.S. Cl. CPC G06F 3/1454; G06F 3/013; G06F 3/017; G06T 11/00; G06T 13/40; G06T 13/80; G06V 20/41; G06V 40/28; H04L 12/1831

(57) ABSTRACT

The disclosed techniques provide features for automatically tethering an interpreter with multiple signers. When an interpreter is tethered to a first user and a second user, the system also automatically directs the attribution for a voice input to either a first signer or a second signer based on an eye gaze direction of the interpreter providing the voice input. When the interpreter speaks, their audio will be routed through the signer's own audio channel, which will give the appearance that the signing user is speaking, e.g., providing a verbal input to the meeting audio stream. This will ensure that the signers are each given proper attribution in generated meeting content, such as, but not limited to, captions, transcription, and meeting summaries.

### BACKGROUND

There are a number of collaborative systems that allow users to communicate. For example, some systems allow people to collaborate by sharing content using live video and audio streams, shared files, chat messages, etc. Users can also establish a communication session at a specific time, e.g., a time slot for an online meeting, where participants can concurrently display people and content.

Although existing collaborative systems provide features that allow people to conduct meetings via live video streams, some of these systems still have a number of drawbacks. For example, some existing systems do not have effective features that accommodate people who need sign language interpreters. In such instances, a meeting attendee can have a sign language interpreter join them in a meeting. The interpreter can observe the meeting attendee and then verbally communicate an interpretation of their observations to the other meeting attendees. For example, deaf or hard-of-hearing (D/HH) attendees of a video conferencing meeting use sign language and require an interpreter to translate sign language into spoken language and vice versa.

When a sign language interpreter is speaking for another meeting attendee, e.g., a signer, some systems typically broadcast the voice input of the interpreter to the audience. This can be confusing to an audience of a live meeting in that the systems often give attribution to the user who is speaking. This means that the audience sees graphical indicators highlighting the interpreter when the interpreter is speaking on behalf of the signer. This occurs even though the signer is the original source of the verbally communicated information. In addition, some existing systems also generate transcripts and meeting summaries that list the name of the interpreter instead of the signer. This can be confusing for a recipient of the transcript and also cause issues if a transcript or a meeting summary is used as an input to an AI model.

The above-described issues are exacerbated in scenarios where a sign language interpreter is speaking on behalf of multiple users. In this situation, a number of additional verbal and non-verbal cues are needed to indicate which one of the signers are being represented by the interpreter. The arrangement of having one interpreter representing multiple signers also requires a high level of coordination as the interpreter could rapidly switch back and forth between the signers. This increases the difficulty in the task of indicating which signer is being represented. For illustrative purposes, consider a scenario where there are three connected users: Signer A, Signer B and an Interpreter. Both Signer A and Signer B have designated Interpreter as someone who can speak on their behalf. However, when the Interpreter voices, that system cannot readily indicate to the audience who the interpreter is voicing for, which could be either Signer A or Signer B. Such scenarios cause a need for further improvements.

### SUMMARY

The disclosed techniques provide features for automatically tethering an interpreter with an individual signer that is selected from multiple signers based on the eye gaze direction of the interpreter and signing activity of the signers. The system can dynamically tether the interpreter to a first signer when the interpreter is looking at an image of the first signer and when the first signer is actively signing. The system can automatically tether the interpreter to a second signer when the interpreter is looking at an image of the second signer and when the first signer stops signing and when the second signer is actively signing. When an interpreter is tethered to a selected signer, the system automatically directs the attribution for a voice input to either the first signer or the second signer based on an eye gaze direction of the interpreter providing the voice input. When the interpreter speaks, their audio will be routed through the signer's own audio channel, which will give the appearance that the signing user is speaking, e.g., providing a verbal input to the meeting audio stream. This will ensure that the signers are each given proper attribution in generated meeting content, such as, but not limited to, captions, transcription, and meeting summaries. The disclosed techniques also ensure that artificial intelligence (AI) analysis that uses the generated meeting content gives proper attribution to the person that is the true source of the shared information.

In one illustrative example, consider a scenario where there are multiple sign languages users sharing a single interpreter. If there is more than one sign language user in a meeting that is using the same sign language interpreter, the system identifies which signer the interpreter is voicing for. The system then displays a graphical indicator highlighting the image or a name of the identified signer. The selected signer can also be credited for the verbal input that is provided by the interpreter. In this example, a system has three connected users: Signer A, Signer B and an interpreter. Both Signer A and Signer B have designated the interpreter as someone who can speak on their behalf. When the interpreter voices, the system uses sensors to track the eye gaze movement of the interpreter and determines which signer the interpreter is looking at. The system also examines a video of each signer to determine if the signers are actively signing. If Signer A is actively signing, has designated the interpreter, and the interpreter is looking at an image of Signer A, the interpreter is automatically tethered to Signer A and the interpreter's audio is routed through Signer A's audio channel. Signer A is then given attribution for the voice input of the interpreter in all summaries, closed captioning text, and transcripts, etc. The interpreter will continue to be tethered to Signer A until Signer A stops signing for a predetermined time period and/or when the interpreter stops looking at the rendering of Signer A for a predetermined time. As soon as this time has elapsed for either or both conditions, the tethering ends, and the two participants are decoupled. When Signer B starts signing, and the interpreter looks at an image of Signer B while the interpreter is voicing, the interpreter then becomes tethered to Signer B, and their audio will be routed through Signer B's audio channel. Signer B is then given attribution for the voice input of the interpreter in all summaries, closed captioning text, and transcripts, etc.

The technical problem of a system requiring complex manual inputs and social cues to coordinate the representation of multiple signers is solved by a technical solution of a system that can dynamically tether an interpreter to a single signer from a group of signers based on the eye gaze direction of the interpreter. By dynamically tethering an interpreter to a single signer, the human interaction, efficiency, and accuracy of a system is improved. This enables a system to more generate transcripts and summaries that more accurately identify the true source of information, instead of improperly giving attribution to the wrong signer or give continuous attribution to the interpreter without regard to those who they are representing.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for automatically tethering an interpreter with an individual signer selected from multiple signers.

FIG. 2A shows a system for automatically tethering an interpreter with an individual signer in a first operating mode where the system gives attribution to the interpreter.

FIG. 2B shows a system for automatically tethering an interpreter with an individual signer in a second operating mode where the system gives attribution to a first signer of a group of signers.

FIG. 2C shows a system for automatically tethering an interpreter with an individual signer in a third operating mode where the system gives attribution to a second signer of a group of signers.

FIG. 3A shows a system in a first operating mode where the system gives attribution to the interpreter in a transcript or summary.

FIG. 3B shows a system in a second operating mode where the system gives attribution to a first signer in a transcript or summary.

FIG. 3C shows a system in a second operating mode where the system gives attribution to a second signer in a transcript or summary.

FIG. 4 shows an embodiment for automatically tethering an interpreter with an individual person selected from multiple people in an AR/VR environment.

FIG. 5 shows permissions for allowing a first select group of users to become interpreters and permissions for allowing another select group of users to become signers.

FIG. 6 shows a user interface that allows users to provide an input indicating if they are a signer or an interpreter.

FIG. 7 shows a mapping that results when the users provide an input indicating if they are a signer or an interpreter.

FIG. 8 is a flow diagram showing aspects of a routine for implementing aspects of the disclosed techniques.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

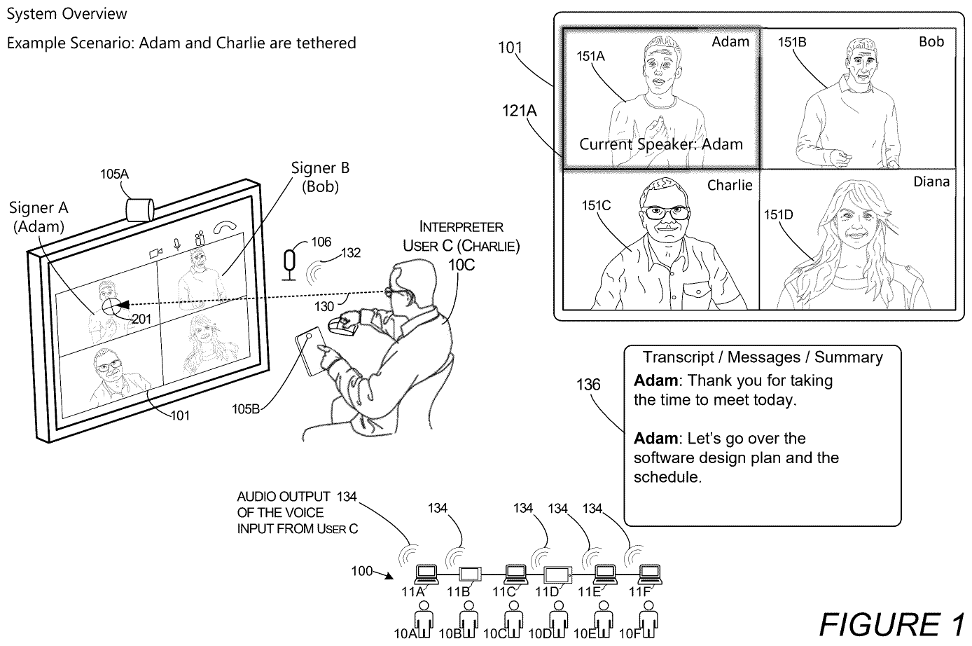

FIG. 1 illustrates a system 100 for automatically tethering an interpreter with an individual signer selected from multiple signers based on the eye gaze direction of the interpreter and signing activity of the signers. When the interpreter is looking at an image of one of the signers, the system automatically tethers the interpreter to that signer when the signer is actively signing. When an interpreter is tethered to a selected signer, the system automatically directs the attribution for a voice input of the interpreter to either a first signer or a second signer based on an eye gaze direction of the interpreter. When the interpreter speaks, their audio will be routed through the signer's own audio channel, which will give the appearance that the signing user is speaking, e.g., providing a verbal input to the meeting audio stream. This will ensure that the signers are each given proper attribution in generated meeting content, such as, but not limited to, captions, transcription, and meeting summaries. The disclosed techniques also ensure that artificial intelligence (AI) analysis that uses the generated meeting content gives proper attribution to the person that is the true source of the shared information.

In this example, the system 100 includes a number of computing devices 11 (also referred to herein as “client devices”) each associated with a user 10. To illustrate aspects of the present disclosure, consider a scenario where six users 10A-10F are involved with a meeting, where User A 10A, Adam, is associated with a first computing device 11A; User B 10B, Bob, is associated with a second computing device 11B; User C 10C, Charlie, is associated with a third computing device 11C; User D 10D, Diana, is associated with a fourth computing device 11D; User E, Edward, is associated with a fifth computing device 11E; User F 10F, Frank, is associated with a sixth computing device 11F. The system can also include a server, as described in more detail below. Although this example shows an example where the users are in a meeting, the techniques disclosed herein can be used without a meeting. The disclosed features can be used in other forms of collaboration sessions, e.g., private calls, a broadcast, etc.

This example includes two signers: a first user 10A, Adam, and a second user 10B, Bob. Also shown, this example includes an interpreter, a third user 10C, Charlie. The system causes the display of a user interface 101 that includes a first rendering 151A of a first live video stream depicting the first user 10A and a second rendering 151B of a second live video stream depicting the second user 10B. The user interface can be displayed on each of the client devices 11. In FIG. 1, the user interface is displayed on the third device 11C of the interpreter, the third user 10C. When the interpreter starts to speak, a device 106 captures the voice input 132 of the interpreter, and an audio stream of that voice input is transmitted to other devices 11 of the other users to generate an audio output 134 containing the voice input at individual devices of the client devices 11A-11F.

The system tracks the eye gaze direction of the interpreter. The system analyzes an input signal generated by one or more sensors 105 at the third device 11C for tracking the eye gaze direction 130 of the third user 10C. The sensors 105 can include a camera 105A in communication with the third device 11C, a mobile device 105B, or any other suitable sensor for tracking the eye gaze direction of the third user. The system can determine if the interpreter is looking at the rendering 151A of the first user 10A or the rendering 151B of the second user 10B.

The system analyzes the activity of the users with signer roles to determine if they are actively signing. The system can accomplish this task by analyzing the first live video stream depicting the first user 10A to determine that the first user is performing one or more predetermined gestures. The system can also concurrently analyze the second live video stream depicting the second user 10B to determine that the second user is performing the one or more predetermined gestures. The performance of one or more predetermined gestures can include any activity that is to be detected for tethering users. The predetermined gestures can include signing, e.g., expressing sign language. The system can detect if the predetermined gestures are being performed for a threshold period of time, or system can detect if a user has stopped performing the predetermined gestures a threshold period of time. The system can monitor any number of streams only for people who are designated as, and permitted to be, signers. Permissions set by an administrator or meeting organizer can set the permissions for allowing a user to have a signer role in a meeting.

In the example shown in FIG. 1, the interpreter's eye gaze direction indicates that the interpreter is looking at the rendering 151A of the first user, Signer A/User 10A. The system also detects that the first user is actively signing. In response to this detection, the system transitions to an operating mode where the first user and the third user are tethered. While the two users are tethered, the first user receives attribution for the voice input 132 of the third user. Giving attribution to the first user 10A can include generating a graphical element 121A associating the voice input with the first user 10A. Giving attribution to the first user can also include generating an identifier (the name Adam) of the first user 10A for labeling a transcription 136 of the voice input provided by the third user. In this case, the transcription of the voice input provided by the third user includes a text translation of the voice input in a transcript, message, summary, or an input to an AI agent.

The disclosed techniques include the display of a UI that displays active users who are non-sign language users as well as active users who are sign language users. As shown in FIG. 1, the user interface shows Adam and Bob who are signers, and Diana who is a non-sign language user. The system is configured to determine an activity type or a category of gestures, e.g., if a person is signing or if a person is actively moving but not expressing a sign language gesture.

This can be done by comparing the detected activity to predetermined gestures and by that comparison, generating data indicating a category of each person's activity. This way, the system can distinguish user activities and only tether the interpreter to people who are actively performing a specific category of gestures. Thus, the techniques can also be applied to other types of activity other than the detection of sign language gestures.

By determining categories of gestures for each person's activities, the system can identify only those who are performing signing language gestures versus those who are performing other categories of gestures. The system can then only dynamically tether an interpreter or speaker for language users.

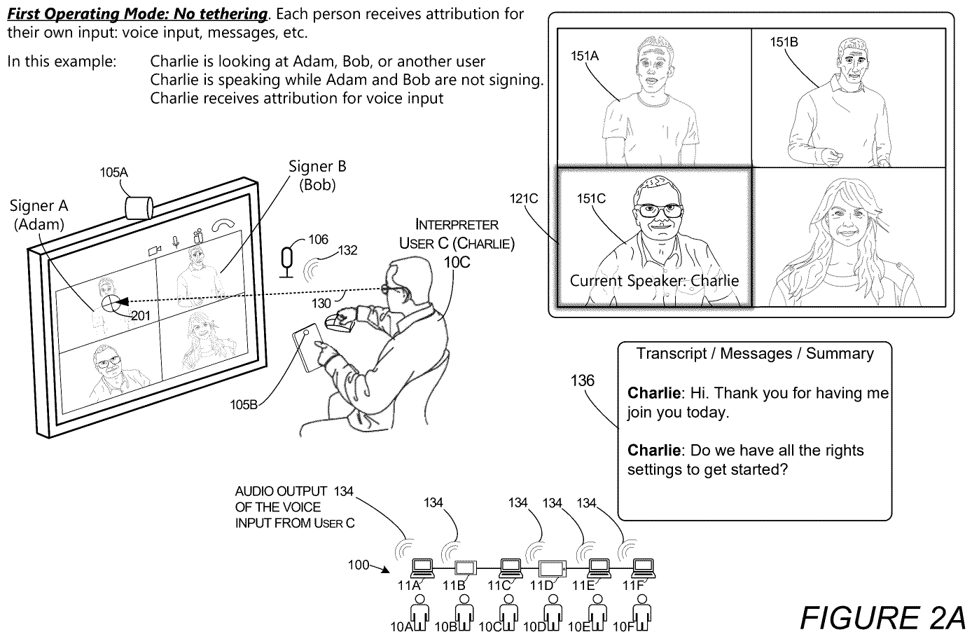

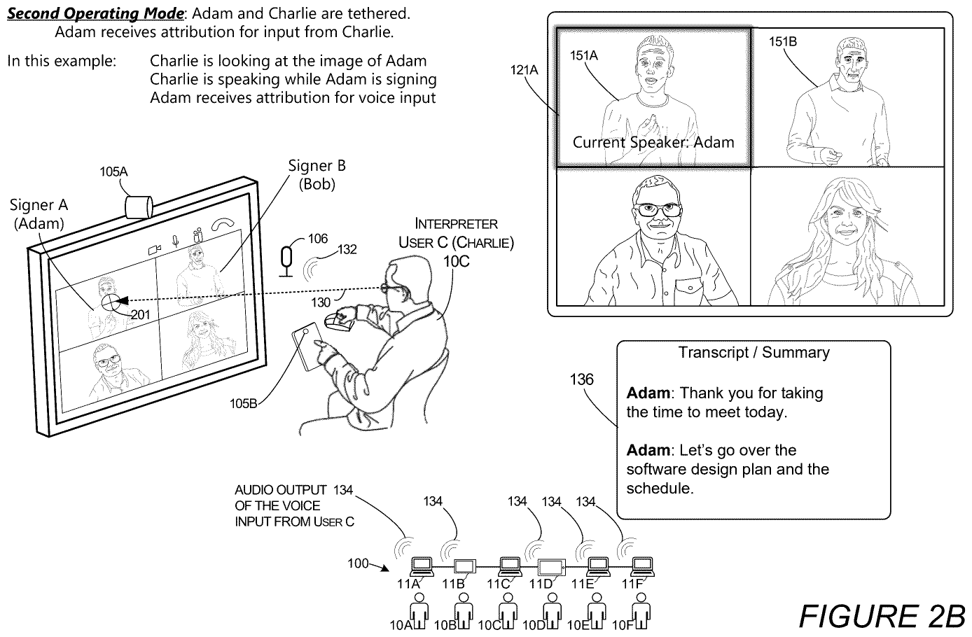

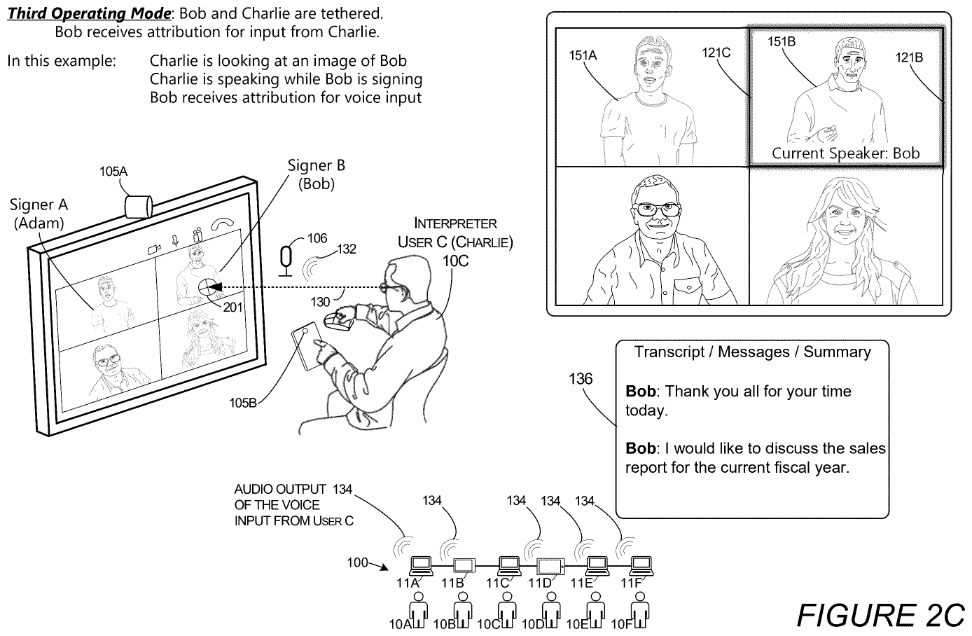

FIGS. 2A-2C show the system transitioning through several operating states where the system gives attribution to different users based on the detection of the interpreter's eye gaze direction and the signing activity of the signers. FIG. 2A shows a first operating mode, where the system highlights the image 151C of the interpreter with a graphical element 121C showing that the third user 10C (the interpreter) is the active speaker. The interpreter's name is also included as a label for the transcription of the speech input provided by the interpreter. In some embodiments, the system is in the starting operating mode when a meeting starts.

FIG. 2B shows a second operating mode, where the first user 10A (the first signer), Adam, is the active speaker. When in the second operating mode, the system highlights the image 151A of the first user 10A with a graphical element 121A showing other users that the first user 10A is the active speaker. The first user's name is also included as a label for the transcription 136 of the speech input provided by the interpreter. The system can transition from the first operating mode to the second operating mode when the detected eye gaze direction of the third user 10C indicates that the third user 10C is looking at the rendering 151A of the first user 10A, and an input signal from the device of the first user indicates that the first user is actively signing.

FIG. 2C shows a third operating mode, where the second user 10B (the second signer), Bob, is the active speaker. When in the third operating mode, the system highlights the rendering 151B of the second user 10B, Bob, with a graphical element 121B showing that the second user 10B is the active speaker. The second user's name is also included as a label for the transcription 136 of the speech input provided by the interpreter. The system can transition from the second operating mode to the third operating mode only when three predetermined activities are determined to meet three separate conditions. The first condition is that the system determines that the eye gaze direction of the third user 10C indicates that the third user 10C is looking at the rendering 151B of the second user 10B for a predetermined period of time. The second condition is that the system determines that the input signal from the device of the second user indicates that the second user 10B is actively signing for a predetermined period of time. The third condition is that the system determines that the first user 10A has stopped signing for a predetermined period of time, e.g., 3-5 seconds, or when the first user 10A indicates they are done signing. The predetermined period of time for each condition can be the same or the period of time for each condition can be different durations.

In the above-described example, when the interpreter is tethered to the first signer, that tethering is maintained until the first signer stops signing and when the second signer starts signing. This combination of conditions prevents unwanted changes in representation. Thus, even if the interpreter looks away from their tethered signer for a few seconds, the system does not decouple the two tethered users until all of the other conditions are met.

In another embodiment, if the interpreter is tethered to the first signer, and the interpreter looks away from the image of the first signer and looks at the image of the second signer, the system does not decouple the interpreter from the first signer until the second signer starts to actively sign.

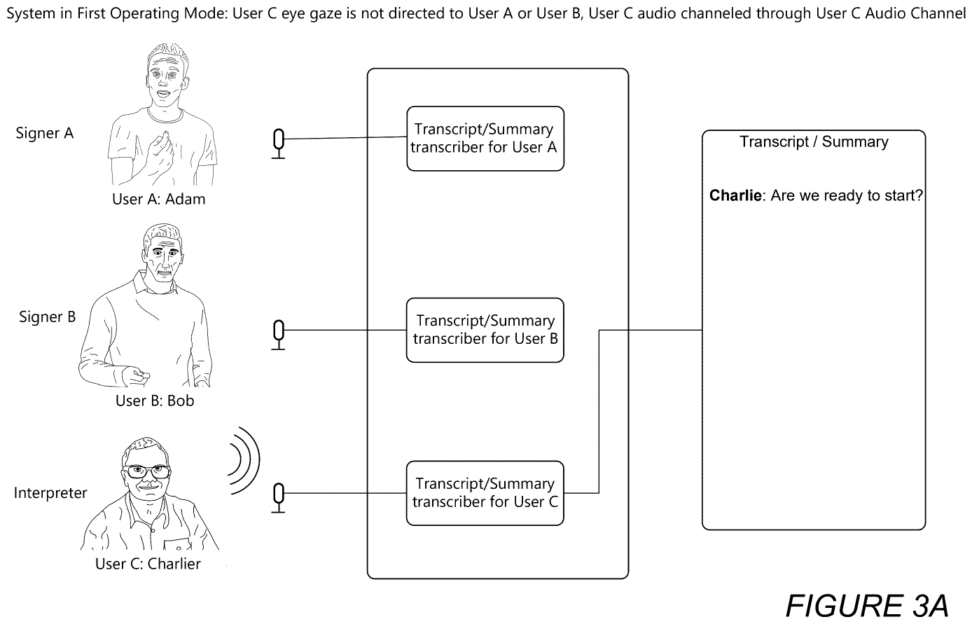

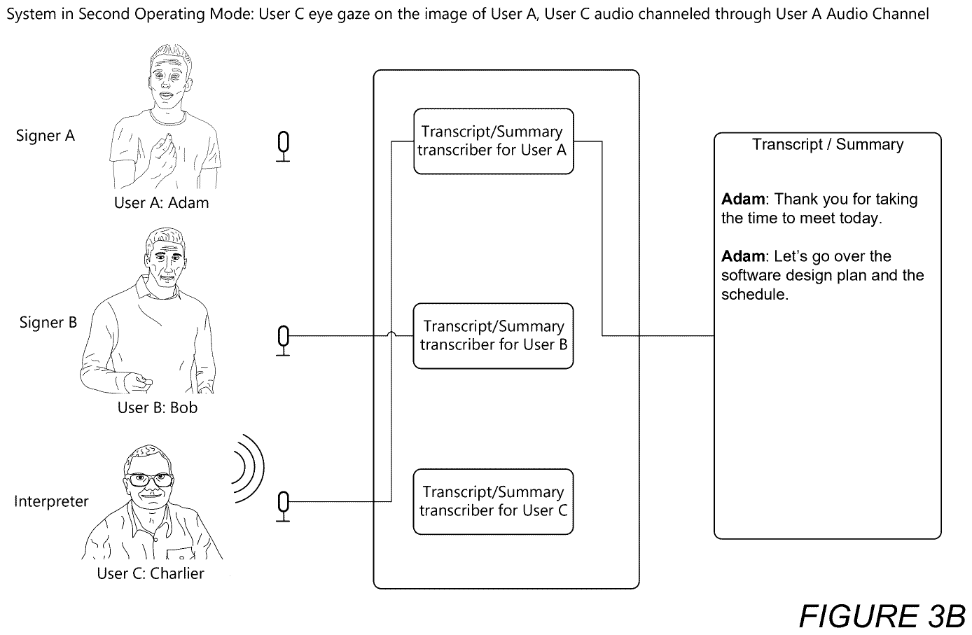

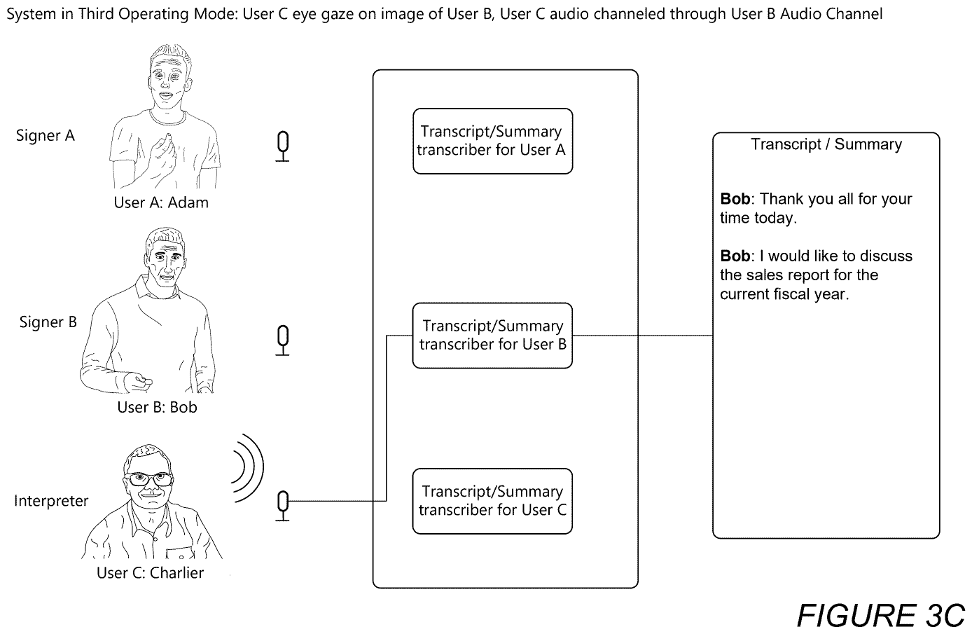

FIGS. 3A-3C show the system transitioning through several operating modes where the system changes the routing of the interpreter's audio stream based on the various operating modes. As shown in FIG. 3A, when in the first operating mode, when the interpreter speaks, the system routes their audio stream through their own audio channel, which will give the appearance that the interpreter is speaking, e.g., providing a verbal input to the meeting audio stream under their own name. As shown in FIG. 3B, when in the second operating mode, when the interpreter speaks, the system routes their audio stream through the audio channel of the first user 10A, which will give the appearance that the first user 10A is speaking, e.g., providing a verbal input to the meeting audio stream under the name of the first user 10A. As shown in FIG. 3C, when in the third operating mode, when the interpreter speaks, the system routes their audio stream through the audio channel of the second user 10B, which will give the appearance that second user 10B is speaking, e.g., providing a verbal input to the meeting audio stream under the name of the second user 10B.

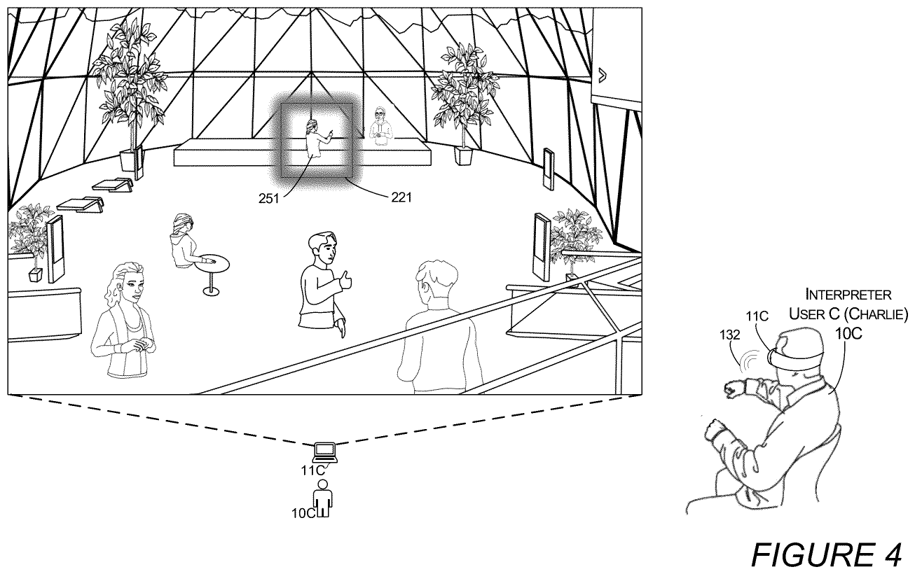

The techniques disclosed herein can be applied to other forms of communication sessions and are not limited to meetings. The techniques can be applied to any form of communication involving live audio and video communications. In one example, as shown in FIG. 4, an interpreter or a speaker 10C is wearing a virtual reality device for an augmented reality device. When the speaker 10C is talking and looking at the rendering of a particular avatar 251, the system can tether the speaker 10C with the person represented by the avatar. This tethering is only invoked when the person represented by the avatar is performing a predetermined gesture (performing a particular category of gestures). Once tethered, the avatar is highlighted with a graphical element 221. In addition, similar to the example described above, attribution is given to the person represented by the avatar in all records created from the communication session.

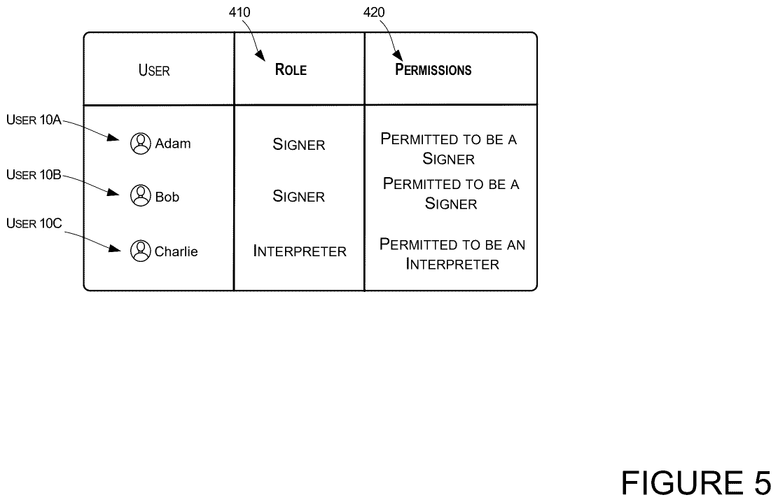

With reference to FIG. 5 through FIG. 7, embodiments for controlling access to meeting roles and tethering functionality are shown and described below. In these embodiments, the system utilizes permissions 420 that allow select users to assume certain roles 410, such as signer roles and interpreter roles. For example, as shown in FIG. 5, to facilitate the example scenarios described above, an administrator or another user with appropriate rights assigns permissions for Adam, Bob, and Charlie. In this example, Adam and Bob are granted permissions to assume a signer role and Charlie is granted permissions to assume an interpreter role. The permissions restrict other users from assuming the signer and interpreter roles.

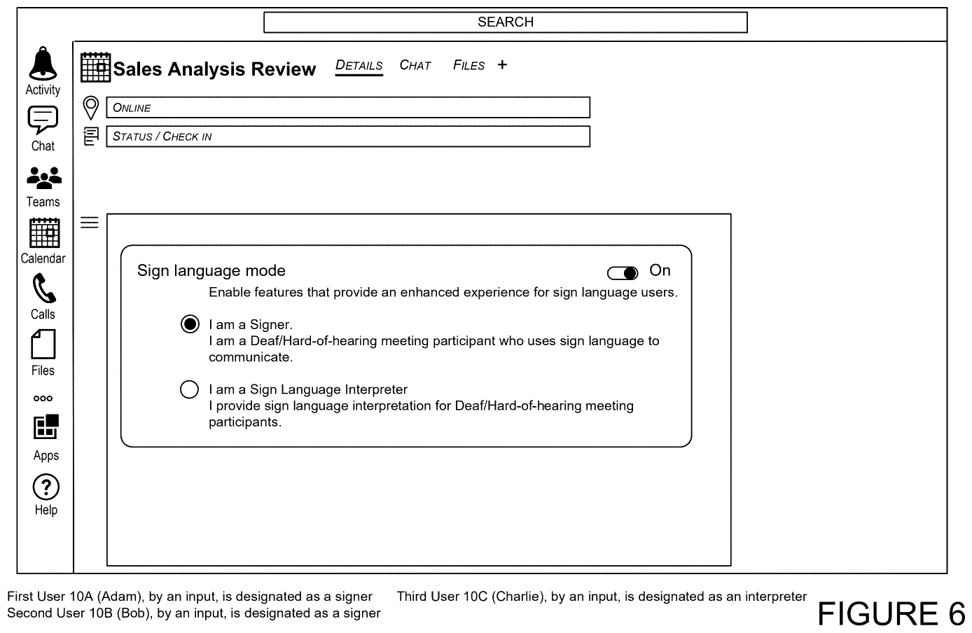

With the established permissions 420, such as those shown in FIG. 5, the permitted users can select their desired role for a single meeting or for multiple meetings. The example of FIG. 6 shows a user interface that is used for allowing a user to select their desired role. In continuing the example described above, Adam and Bob utilize the user interface to select signer roles and Charlie selects an interpreter role.

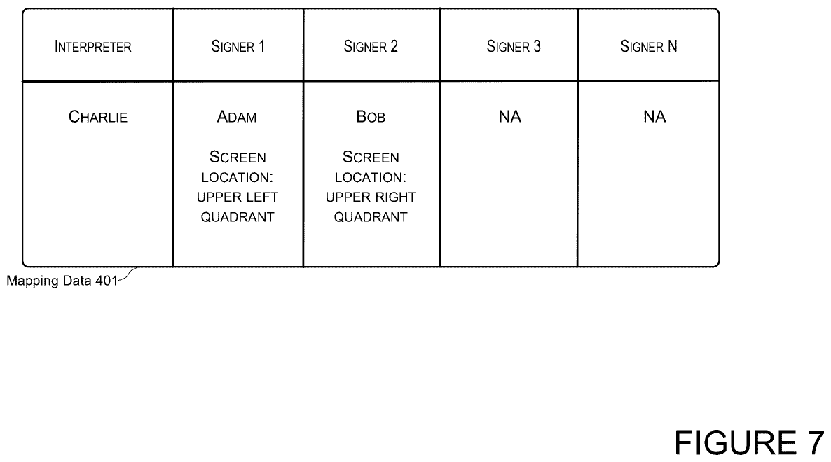

In response to the user selection of the signer and interpreter roles, the system generates mapping data 401 shown in FIG. 7 that assigns each signer to an interpreter. This mapping data also stores the position of each signer image on the user interface. This allows the system to dynamically tether each signer to the interpreter based on the eye gaze direction of the interpreter. The mapping data is also accessed by the system to determine which users to monitor for specified gestures. For instance, once the mapping assignments are created, the mapping data causes the system to monitor the eye gaze direction of the interpreter. The mapping data also causes the system to monitor the activity of each signer to determine if they are actively signing or if they have stopped signing. To improve the efficiency of the system, the mapping data and the permissions direct the system to only monitor the activity to a select subset of users, instead of monitoring the activity of all users in a meeting or call. In some embodiments, the system only monitors the eye gaze direction of the interpreter only when the interpreter is actively talking. The system conserves energy and improves efficiency by controlling when the system is actively using the sensors to track eye gaze direction, and the system deactivates the sensors when the person is not actively talking. This efficiency is particularly helpful in a situation where there is a near-to-eye AR/VR device where battery conservation is a high priority.

The selection of the interpreters for each signer can involve a manual selection process, as described above with respect to FIG. 6, or the selection of the interpreters for each signer can be automated. A system can be set to an automated mode by an individual with sufficient permissions such as an administrator or meeting organizer. The automated mode utilizes settings to facilitate a match between individual signers and interpreters. For instance, if a meeting has 4 signers and 2 interpreters, the system may assign to signers for each interpreter to balance the assignments. Once matched, the system analyzes the video streams of the signers and interpreters to determine when they are to be dynamically tethered according to the embodiments described herein.

The settings (also referred to herein as permissions) define individual prerequisites for the participant. For example, the settings can define a prerequisite indicating that the participant is in need of a sign language interpreter or that the participant is in need of hearing assistance or another type of assistance. The settings can be accessed by the system each time a communication session, e.g., a meeting, starts so that the system can identify an assistant (also referred to herein as an interpreter) for the participant prior to the start of each meeting. This avoids the need for the participant to search for, and select, an assistant who can help with the participant's prerequisites. This avoids the need for the participant to coordinate with other users and mitigates the need for the participant to perform a number of manual inputs, which can be distracting to all attendees and inefficient with respect to computing resources.

In some embodiments, the system can identify a particular person as an interpreter (an “assistant) by identifying a role that corresponds with the participant's prerequisites. For example, if the participant's prerequisites indicate that the participant is hard-of-hearing, and another person has role as a “sign language interpreter” the system may identify that particular interpreter as the signer's assistant. In response to the selection of the assistant, the system then allows for a dynamic tethering using the criteria using the eye gaze direction of the interpreter and the activity of a signer described herein.

In some embodiments, the system can access permissions that persist across multiple communication sessions for the first user and the second user. The permissions define individual prerequisites for each user, the access to the permissions is automatically performed by the system without requiring a user input. The access to the permissions invokes an automated selection of a match between the first user and the third user based on a prerequisite of the first user matching a role of the third user, where the role of the third user is compatible with the prerequisite. The match between the first user and the third user enables the system to automatically and dynamically tether the first user and the third user, the first user and the third user being tethered if the eye gaze direction of the third user (10C) causes the target region (201) to be positioned to meet the predetermined condition with respect to the first rendering while the first user is performing the one or more predetermined gestures.

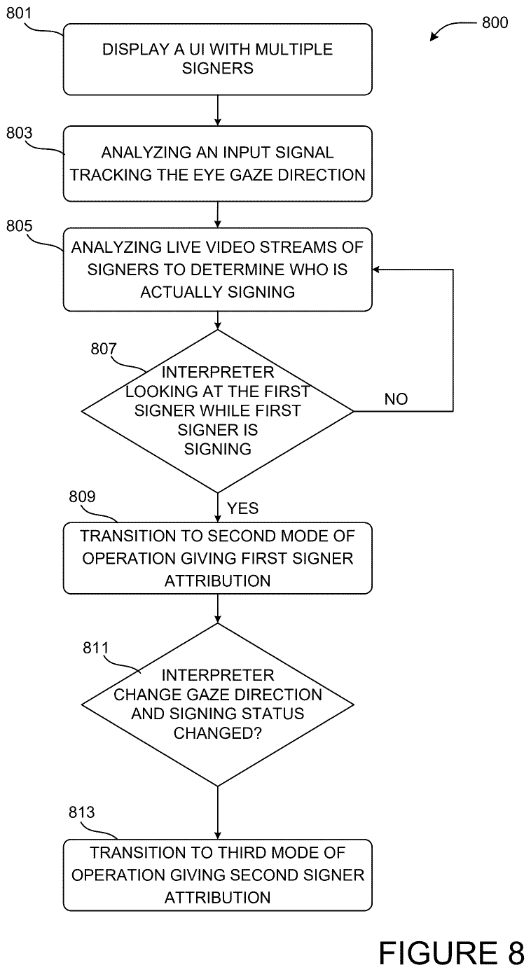

Turning now to FIG. 8, the following section describes aspects of a routine 800 for implementing aspects of the disclosed techniques. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

In this example, the routine 800 causes a system to automatically direct attribution for a voice input to a first user 10A or a second user 10B based on an eye gaze direction of a third user 10C that is providing the voice input.

The routine 800 starts at operation 802, where the system displays a UI with multiple signers. In this example, the system causes a display of a user interface 101 comprising a first rendering 151A of a first live video stream depicting the first user 10A and a second rendering 151B of a second live video stream depicting the second user 10B. The user interface 101 displayed on a client computing device 11C of the third user 10C.

At operation 803, the system analyzes an input signal tracking the eye gaze direction of the interpreter. In this example, the system analyzes an input signal generated by one or more sensors 105 at the client computing device 11C tracking the eye gaze direction 130 of the third user 10C, the eye gaze direction 130 controlling a position of a target region 201 within the user interface 101.

At operation 805, the system analyzes the first live video stream depicting the first user 10A to determine that the first user is performing one or more predetermined gestures and analyzing the second live video stream depicting the second user 10B to determine that the second user is performing the one or more predetermined gestures. This operation includes analyzing the video stream of each person to determine which signer is signing. Performing one or more predetermined gestures includes signing, e.g., expressing sign language.

At operation 807, the system determines that the interpreter is looking at the first signer while first signer is signing. In this operation, when the interpreter is looking at the first signer while the first signer is performing signing gestures, the system tethers the first and third user and gives attribution of the third user's speech to the first signer. This includes determining that the input signal indicates that the eye gaze direction of the third user 10C causes the target region 201 to be positioned to meet a predetermined condition with respect to the first rendering 151A depicting the first user 10A while the first user is performing the one or more predetermined gestures. In some embodiments, the target region 201 is positioned to meet a predetermined condition with respect to the first rendering 151A when the target region 201 has a threshold overlap with the first rendering 151A. In some embodiments, the target region 201 is positioned to meet a predetermined condition with respect to the first rendering 151A when the target region 201 is within a threshold distance from the first rendering 151A. If the target region 201 is positioned not to meet the predetermined condition with respect to the first rendering 151A, the routine 800 returns to operation 805 where the system continues to analyze the live video streams of each user.

If the target region 201 is positioned to meet the predetermined condition with respect to the first rendering 151A and if the first user is signing, at operation 809, the system transitions from a first operating mode to a second operating mode. This includes causing a transition from a first operating mode to a second operating mode, in response to determining that the input signal indicates that the eye gaze direction of the third user 10C causes the target region 201 to be positioned to meet the predetermined condition with respect to the first rendering 151A depicting the first user 10A while the first user is performing the one or more predetermined gestures, e.g., while the first user is signing.

In this routine, the system is in the first operating mode before the eye gaze of the interpreter is directed to Signer A (the second user) or if the system detects that Signer A not signing. In the first operating mode, as shown in FIG. 2A, the interpreter receives attribution for his own speech input. The system highlights the image of the interpreter with a first graphical element 121A showing that the third user is the active speaker.

The first operating mode includes generating a first graphical 121A element associating the voice input with the third user 10C. This display of the first graphical element 121A indicates that the third user is an active speaker. The first operating mode further causing the system to include an identifier of the third user 10C for labeling a transcription of the voice input provided by the third user. The transcription can include close caption text, a transcript, meeting notes, text that is included in messages, etc.

The second operating mode is caused by eye gaze of the interpreter at first signer while the first signer is signing, where the first signer receives attribution. The second operating mode includes generating a second graphical element 121B associating the voice input with the first user 10A. The second operating mode further causes the system to include an identifier of the first user 10A for labeling the transcription of the voice input provided by the third user.

At operation 811, the system determines if the interpreter changes his or her eye gaze direction and determines if the first signer has stopped signing. In some embodiments, operation 811 includes determining that interpreter is looking at a second signer while the second signer is signing, and after the first signer has stopped signing. Operation 811 includes analyzing the first live video stream depicting the first user 10A to determine that the first user has stopped performing the one or more predetermined gestures. Operation 811 also includes analyzing the input signal to determine that the eye gaze direction of the third user causes the location of the target region 201 to meet the predetermined condition with respect to the second rendering 151B depicting the second user 10B.

Then, at operation 813, the system gives attribution to Signer B (the second user) in response to determining that the first user has stopped performing the one or more predetermined gestures (only when Signer A has stopped signing for a predetermined period of time) and determining that the target region 201 meets the predetermined condition with respect to the second rendering 151B depicting the second user 10B (e.g., that the interpreter is looking at the second user. The system gives attribution to Signer B (the second user) by causing a transition from the second operating mode to a third operating mode. Where the third operating mode causes the system to generate a third graphical element 121C to associate the voice input with the second user 10B. The third operating mode further causing the system to include an identifier of the second user 10B for labeling the transcription of the voice input provided by the third user 10C.

The system can also transition from the second operating mode to the first operating mode when the first user stops signing for a predetermined time period and/or when the interpreter stops looking at the rendering of the first user for a predetermined time. As soon as the predetermined time has elapsed for either or both conditions, the tethering ends, and the two participants are decoupled, and the system routes the audio stream of the third user through their own audio channel, which will give the appearance that the third user is speaking, e.g., the highlights are rendered on the image of the third user and/or the transcription of the voice input is credited to the third user.

In some embodiments, the routine also includes the display the user interface that further comprises another rendering 151D of a fourth user 10D. In this embodiment, the system analyzes live video streams depicting each user to determine an activity category for each user based on one or more gestures performed by individual users, determines that the first user and the second user are performing a first activity category indicating a performance of one or more sign language gestures, and determines that the fourth user is performing a second activity category indicating a performance of a gesture that does not include sign language gestures. In some embodiments, the system analyzes live video streams depicting select users to determine an activity category for the select users having a predetermined role, prerequisite (signer) or designation.

The system then sets permissions for allowing the third user to be tethered with the first user or the second user in response to determining that the first user and the second user are performing the first activity category indicating the performance of one or more sign language gestures, wherein permissions for allowing the third user to be tethered with the first user or the second user allows the system to transition to the second operating mode and the third operating mode.

The system also sets permissions for restricting the third user from being tethered with the fourth user in response to determining that the fourth user is performing a second activity category indicating a performance of a gesture that does not include sign language gestures, wherein permissions for restricting the third user from being tethered with the fourth user prevents a display of a graphical element associating the voice input with the fourth user, and prevents the system to include an identifier of the fourth user for labeling the transcription of the voice input provided by the fourth user.

In some embodiments, the system limits the analysis of input signals and live video streams to conserve energy. The system only analyzes live video streams and input signals of users having certain permissions. For example, the system determines that the first user and the second user have permissions to be represented by the third user. The system then initiates the analysis to the first live stream and the second live stream for determining activity with respect to the predetermined gestures, in response to determining that the first user and the second user have permissions to be represented by the third user. The other streams of other users are not analyzed for detecting performance of the one or more predetermined gestures if users depicted in the other streams do not have permissions to be represented by the third user.

The system also determines that the third user has permissions to represent the first user and the second user. The system then initiates the analysis of the input signal generated by one or more sensors, in response to determining that the third user has permissions to represent the first user and the second user. The system does not analyze other input signals generated by other sensors for detecting an eye gaze direction of another user if the other users do not have permissions to represent the first user and the second user.

Although the examples described herein refer to the use of a large language model, the techniques disclosed herein can utilize any combination of suitable Natural Language Processing (NLP) algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

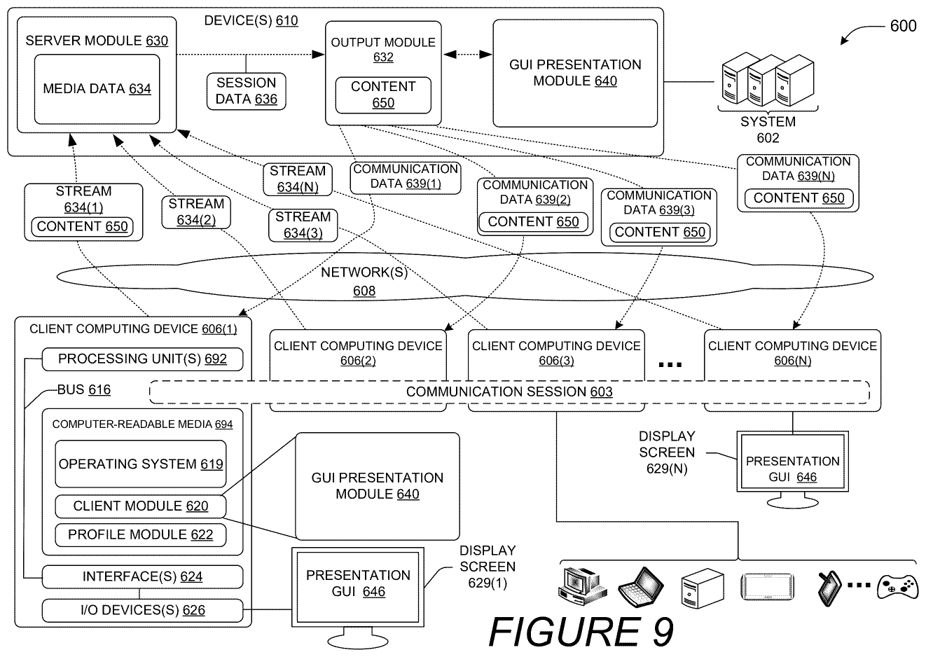

Turning now to FIG. 9, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 9 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 9 illustrates that client computing device 606(1) is in some way connected to a display device (e.g., a display screen 629(N)), which can display a UI according to the techniques described herein.

In the example environment 600 of FIG. 9, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 9) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 9, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

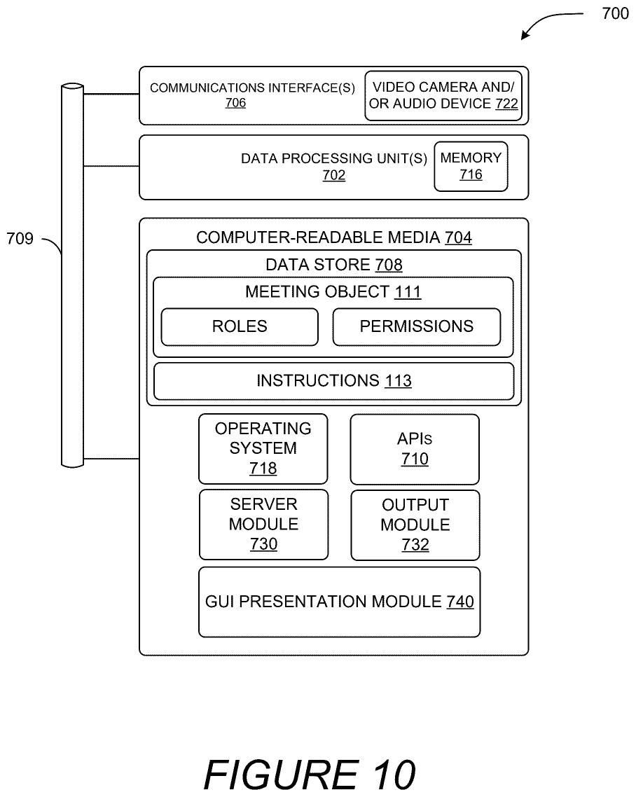

FIG. 10 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which is also referred to herein as computer-readable storage media, a computer-readable medium, or computer-readable storage medium, includes one or more of volatile memory, nonvolatile memory, and/or other persistent and/or auxiliary computer storage media, rotating storage medium such as a disk, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

A “computer-readable storage device” or a “computer-readable device” includes non-transitory computer-readable storage media such as one or more of volatile memory, nonvolatile memory implemented in any method or technology for storage of information such as computer-readable instructions, data structures, program modules, or other data. Thus, a computer-readable storage device includes tangible and/or physical forms of a hardware component that is part of a computing system or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), or flash memory, solid-state memory devices, storage arrays, network attached storage, storage area networks. The computer-readable storage device also includes a physical hardware device having circuitry and magnetic sensors, optical sensors, or other sensors for reading a compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, or any other physical locally stored medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the meeting objects described herein. The session data 714 can also include video, audio, or other content that can be shared in a meeting. The session data can also include permissions for each user. For example, session data can indicate that past meetings included users having speaker roles and other roles. This data can also indicate preferences, e.g., that a user wants to join meetings with RTT activated for each meeting or only certain events having attributes that meet one more criteria, e.g., with predetermined invitees or meetings having shared content having a predetermined subject. The permissions can define specific instructions that are permitted and restricted during different states of a meeting or call that is in progress. For example, based on a role in a meeting, e.g., organizer or administrator, some users may have permissions to start or stop the RTT mode in a meeting, while others are restricted from such operations.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for automatically directing attribution for a voice input to a first user or a second user based on an eye gaze direction of a third user that is providing the voice input, the method for execution on a system, the method comprising:
causing a display of a user interface comprising a first rendering of a first live video stream depicting the first user and a second rendering of a second live video stream depicting the second user, the user interface displayed on a client computing device of the third user;
analyzing an input signal generated by one or more sensors at the client computing device tracking the eye gaze direction of the third user, the eye gaze direction controlling a position of a target region within the user interface;
analyzing the first live video stream depicting the first user to determine that the first user is performing one or more predetermined gestures and analyzing the second live video stream depicting the second user to determine that the second user is performing the one or more predetermined gestures;
determining that the input signal indicates that the eye gaze direction of the third user causes the target region to be positioned to meet a predetermined condition with respect to the first rendering depicting the first user while the first user is performing the one or more predetermined gestures;
in response to determining that the input signal indicates that the eye gaze direction of the third user causes the target region to be positioned to meet the predetermined condition with respect to the first rendering depicting the first user while the first user is performing the one or more predetermined gestures,
causing a transition from a first operating mode to a second operating mode,
wherein the first operating mode includes generating an interpreter graphical element associating the voice input of the third user with a rendering of the third user, the first operating mode further causing the system to include an identifier of the third user for labeling a transcription of the voice input provided by the third user, wherein the second operating mode includes generating a first graphical element associating the voice input of the third user with the rendering of the first user, the second operating mode further causing the system to include an identifier of the first user for labeling the transcription of the voice input provided by the third user;
analyzing the first live video stream depicting the first user to determine that the first user has stopped performing the one or more predetermined gestures;
analyzing the input signal to determine that the eye gaze direction of the third user causes the location of the target region to meet the predetermined condition with respect to the second rendering depicting the second user; and
in response to determining that the first user has stopped performing the one or more predetermined gestures and determining that the target region meets the predetermined condition with respect to the second rendering depicting the second user while the second user is performing the one or more predetermined gestures, causing a transition from the second operating mode to a third operating mode, wherein the third operating mode causes the system to generate a second graphical element associating the voice input of the third user with the rendering of the second user, the third operating mode further causing the system to include an identifier of the second user for labeling the transcription of the voice input provided by the third user.

2. The method of claim 1, wherein the user interface further comprises another rendering of a fourth user, wherein the method further comprises:
analyzing live video streams depicting each user to determine an activity category for each user based on one or more gestures performed by individual users;
determining that the first user and the second user are performing a first activity category indicating a performance of one or more sign language gestures;
determining that the fourth user is performing a second activity category indicating a performance of a gesture that does not include sign language gestures;
setting permissions for allowing the third user to be tethered with the first user or the second user in response to determining that the first user and the second user are performing the first activity category indicating the performance of one or more sign language gestures, wherein permissions for allowing the third user to be tethered with the first user or the second user allows the system to transition to the second operating mode and the third operating mode; and
setting permissions for restricting the third user from being tethered with the fourth user in response to determining that the fourth user is performing a second activity category indicating a performance of a gesture that does not include sign language gestures, wherein permissions for restricting the third user from being tethered with the fourth user prevents a display of a graphical element associating the voice input with the fourth user, and prevents the system to include an identifier of the fourth user for labeling the transcription of the voice input provided by the fourth user.

3. The method of claim 1, wherein the client computing device of the third user is a near-to-eye display device having one or more sensors for detecting the eye gaze direction of the third user, wherein the first rendering depicting the first user is a first avatar representing the first user, the second rendering depicting the second user is a second avatar representing the second user.

4. The method of claim 1, further comprising:
receiving a first input from a first device of the first user, the first input indicating that the first user has selected a signer role;
updating a meeting object with permissions for allowing the first user to the signer role, the signer role allowing the first user to be tethered to any one user with an interpreter role, other users not having the signer role is restricted from being tethered to any one user with the interpreter role;
receiving a second input from a second device of the second user, the second input indicating that the second user has selected the signer role;
updating the meeting object with permissions for allowing the second user to the signer role, the signer role allowing the second user to be tethered to the any one user with the interpreter role, other users not having the signer role is restricted from being tethered to any one user with the interpreter role;
receiving a third input from a third device of the third user, the third input indicating that the third user has selected an interpreter role; and
updating the meeting object with permissions for allowing the third user to the interpreter role, the interpreter role allowing the third user to be tethered to one or more users with the signer role, other users not having the interpreter role is restricted from being tethered to the one or more users with the signer role, wherein the permissions allowing the allowing the third user to be tethered to one or more users enables the system to function in the second operating mode and the third operating mode.

5. The method of claim 1, further comprising: accessing permissions that persist across multiple communication sessions for the first user and the second user, the permissions define individual prerequisites for each user, the access to the permissions is automatically performed by the system without requiring a user input, where the access to the permissions invokes an automated selection of a match between the first user and the third user based on a prerequisite of the first user matching a role of the third user, wherein the role of the third user is compatible with the prerequisite, wherein the match between the first user and the third user enables the system to automatically and dynamically tether the first user and the third user, the first user and the third user being tethered if the eye gaze direction of the third user causes the target region to be positioned to meet the predetermined condition with respect to the first rendering while the first user is performing the one or more predetermined gestures.

6. The method of claim 1, further comprising:
determining that the first user and the second user have permissions to be represented by the third user;
initiating the analysis to the first live stream and the second live stream in response to determining that the first user and the second user have permissions to be represented by the third user, wherein other streams of other users are not analyzed for detecting performance of the one or more predetermined gestures if users depicted in the other streams do not have permissions to be represented by the third user;
determining that the third user has permissions to represent the first user and the second user; and
initiating the analysis of the input signal generated by one or more sensors in response to determining that the third user has permissions to represent the first user and the second user, wherein the system does not analyze other input signals generated by other sensors for detecting an eye gaze direction of another user if the other users do not have permissions to represent the first user and the second user.

7. The method of claim 1, wherein the system causes a generation of an audio output 134 that includes an audio rendering of the voice input of the third user, wherein the audio output 134 is generated at the remote client devices 11A-11F of the system, wherein the first graphical element, the second graphical element and the third graphical element are dynamically displayed while the third user is actively speaking, and the first graphical element, and the first graphical element, the second graphical element and the third graphical element are not actively displayed when the third user is not actively speaking.

8. A computing system for automatically directing attribution for a voice input to a first user or a second user based on an eye gaze direction of a third user that is providing the voice input, the computing system comprising:
one or more processing units; and
a computer-readable storage medium having encoded thereon computer-executable instructions to cause the one or more processing units to:
cause a display of a user interface comprising a first rendering of a first live video stream depicting the first user and a second rendering of a second live video stream depicting the second user, the user interface displayed on a client computing device of the third user;
analyze an input signal generated by one or more sensors at the client computing device tracking the eye gaze direction of the third user, the eye gaze direction controlling a position of a target region within the user interface;
analyze the first live video stream depicting the first user to determine that the first user is performing one or more predetermined gestures and analyzing the second live video stream depicting the second user to determine that the second user is performing the one or more predetermined gestures;
determine that the input signal indicates that the eye gaze direction of the third user causes the target region to be positioned to meet a predetermined condition with respect to the first rendering depicting the first user while the first user is performing the one or more predetermined gestures;
in response to determining that the input signal indicates that the eye gaze direction of the third user causes the target region to be positioned to meet the predetermined condition with respect to the first rendering depicting the first user while the first user is performing the one or more predetermined gestures:
cause a transition from a first operating mode to a second operating mode,
wherein the first operating mode includes generating an interpreter graphical element associating the voice input of the third user with a rendering of the third user, the first operating mode further causing the system to include an identifier of the third user for labeling a transcription of the voice input provided by the third user;
wherein the second operating mode includes generating a first graphical element associating the voice input of the third user with the rendering of the first user, the second operating mode further causing the system to include an identifier of the first user for labeling the transcription of the voice input provided by the third user;
analyze the first live video stream depicting the first user to determine that the first user has stopped performing the one or more predetermined gestures;
analyze the input signal to determine that the eye gaze direction of the third user causes the location of the target region to meet the predetermined condition with respect to the second rendering depicting the second user; and
in response to determining that the first user has stopped performing the one or more predetermined gestures and determining that the target region meets the predetermined condition with respect to the second rendering depicting the second user while the second user is performing the one or more predetermined gestures, cause a transition from the second operating mode to a third operating mode, wherein the third operating mode causes the system to generate a second graphical element associating the voice input of the third user with the rendering of the second user, the third operating mode further causing the system to include an identifier of the second user for labeling the transcription of the voice input provided by the third user.

9. The system of claim 8, wherein the user interface further comprises another rendering of a fourth user, wherein the computer-executable instructions further cause the one or more processing units to:
analyzing live video streams depicting each user to determine an activity category for each user based on one or more gestures performed by individual users;
determining that the first user and the second user are performing a first activity category indicating a performance of one or more sign language gestures;
determining that the fourth user is performing a second activity category indicating a performance of a gesture that does not include sign language gestures;
setting permissions for allowing the third user to be tethered with the first user or the second user in response to determining that the first user and the second user are performing the first activity category indicating the performance of one or more sign language gestures, wherein permissions for allowing the third user to be tethered with the first user or the second user allows the system to transition to the second operating mode and the third operating mode; and
setting permissions for restricting the third user from being tethered with the fourth user in response to determining that the fourth user is performing a second activity category indicating a performance of a gesture that does not include sign language gestures, wherein permissions for restricting the third user from being tethered with the fourth user prevents a display of a graphical element associating the voice input with the fourth user, and prevents the system to include an identifier of the fourth user for labeling the transcription of the voice input provided by the fourth user.

10. The system of claim 8, wherein the client computing device of the third user is a near-to-eye display device having one or more sensors for detecting the eye gaze direction of the third user, wherein the first rendering depicting the first user is a first avatar representing the first user, the second rendering depicting the second user is a second avatar representing the second user.

11. The system of claim 8, wherein the computer-executable instructions further cause the one or more processing units to:
receive a first input from a first device of the first user, the first input indicating that the first user has selected a signer role;
update a meeting object with permissions for allowing the first user to the signer role, the signer role allowing the first user to be tethered to any one user with an interpreter role, other users not having the signer role is restricted from being tethered to any one user with the interpreter role;
receive a second input from a second device of the second user, the second input indicating that the second user has selected the signer role;
update the meeting object with permissions for allowing the second user to the signer role, the signer role allowing the second user to be tethered to the any one user with the interpreter role, other users not having the signer role is restricted from being tethered to any one user with the interpreter role;
receive a third input from a third device of the third user, the third input indicating that the third user has selected an interpreter role; and
update the meeting object with permissions for allowing the third user to the interpreter role, the interpreter role allowing the third user to be tethered to one or more users with the signer role, other users not having the interpreter role is restricted from being tethered to the one or more users with the signer role, wherein the permissions allowing the allowing the third user to be tethered to one or more users enables the system to function in the second operating mode and the third operating mode.

12. The system of claim 8, wherein the computer-executable instructions further cause the one or more processing units to: access permissions that persist across multiple communication sessions for the first user and the second user, the permissions define individual prerequisites for each user, the access to the permissions is automatically performed by the system without requiring a user input, where the access to the permissions invokes an automated selection of a match between the first user and the third user based on a prerequisite of the first user matching a role of the third user, wherein the role of the third user is compatible with the prerequisite, wherein the match between the first user and the third user enables the system to automatically and dynamically tether the first user and the third user, the first user and the third user being tethered if the eye gaze direction of the third user causes the target region to be positioned to meet the predetermined condition with respect to the first rendering while the first user is performing the one or more predetermined gestures.

13. The system of claim 8, wherein the computer-executable instructions further cause the one or more processing units to:
determine that the first user and the second user have permissions to be represented by the third user;
initiate the analysis to the first live stream and the second live stream in response to determining that the first user and the second user have permissions to be represented by the third user, wherein other streams of other users are not analyzed for detecting performance of the one or more predetermined gestures if users depicted in the other streams do not have permissions to be represented by the third user;
determine that the third user has permissions to represent the first user and the second user; and
initiate the analysis of the input signal generated by one or more sensors in response to determining that the third user has permissions to represent the first user and the second user, wherein the system does not analyze other input signals generated by other sensors for detecting an eye gaze direction of another user if the other users do not have permissions to represent the first user and the second user.

14. The system of claim 8, wherein the computer-executable instructions further cause the one or more processing units to cause a generation of an audio output 134 that includes an audio rendering of the voice input of the third user, wherein the audio output 134 is generated at the remote client devices 11A-11F of the system, wherein the first graphical element, the second graphical element and the third graphical element are dynamically displayed while the third user is actively speaking, and the first graphical element, and the first graphical element, the second graphical element and the third graphical element are not actively displayed when the third user is not actively speaking.

15. A computer-readable storage medium having encoded thereon computer-executable instructions for automatically directing attribution for a voice input to a first user or a second user based on an eye gaze direction of a third user that is providing the voice input, the computer-executable instructions configured to cause one or more processing units of a computing system to:
cause a display of a user interface comprising a first rendering of a first live video stream depicting the first user and a second rendering of a second live video stream depicting the second user, the user interface displayed on a client computing device of the third user;
analyze an input signal generated by one or more sensors at the client computing device tracking the eye gaze direction of the third user, the eye gaze direction controlling a position of a target region within the user interface;
analyze the first live video stream depicting the first user to determine that the first user is performing one or more predetermined gestures and analyzing the second live video stream depicting the second user to determine that the second user is performing the one or more predetermined gestures;
determine that the input signal indicates that the eye gaze direction of the third user causes the target region to be positioned to meet a predetermined condition with respect to the first rendering depicting the first user while the first user is performing the one or more predetermined gestures;
in response to determining that the input signal indicates that the eye gaze direction of the third user causes the target region to be positioned to meet the predetermined condition with respect to the first rendering depicting the first user while the first user is performing the one or more predetermined gestures:
cause a transition from a first operating mode to a second operating mode,
wherein the first operating mode includes generating an interpreter graphical element associating the voice input of the third user with a rendering of the third user, the first operating mode further causing the system to include an identifier of the third user for labeling a transcription of the voice input provided by the third user;
wherein the second operating mode includes generating a first graphical element associating the voice input of the third user with the rendering of the first user, the second operating mode further causing the system to include an identifier of the first user for labeling the transcription of the voice input provided by the third user;
analyze the first live video stream depicting the first user to determine that the first user has stopped performing the one or more predetermined gestures;
analyze the input signal to determine that the eye gaze direction of the third user causes the location of the target region to meet the predetermined condition with respect to the second rendering depicting the second user; and
in response to determining that the first user has stopped performing the one or more predetermined gestures and determining that the target region meets the predetermined condition with respect to the second rendering depicting the second user while the second user is performing the one or more predetermined gestures, cause a transition from the second operating mode to a third operating mode, wherein the third operating mode causes the system to generate a second graphical element associating the voice input of the third user with the rendering of the second user, the third operating mode further causing the system to include an identifier of the second user for labeling the transcription of the voice input provided by the third user.

16. The computer-readable storage medium of claim 15, wherein the user interface further comprises another rendering of a fourth user, wherein the computer-executable instructions further cause the one or more processing units to:
analyzing live video streams depicting each user to determine an activity category for each user based on one or more gestures performed by individual users;
determining that the first user and the second user are performing a first activity category indicating a performance of one or more sign language gestures;
determining that the fourth user is performing a second activity category indicating a performance of a gesture that does not include sign language gestures;
setting permissions for allowing the third user to be tethered with the first user or the second user in response to determining that the first user and the second user are performing the first activity category indicating the performance of one or more sign language gestures, wherein permissions for allowing the third user to be tethered with the first user or the second user allows the system to transition to the second operating mode and the third operating mode; and
setting permissions for restricting the third user from being tethered with the fourth user in response to determining that the fourth user is performing a second activity category indicating a performance of a gesture that does not include sign language gestures, wherein permissions for restricting the third user from being tethered with the fourth user prevents a display of a graphical element associating the voice input with the fourth user, and prevents the system to include an identifier of the fourth user for labeling the transcription of the voice input provided by the fourth user.

17. The computer-readable storage medium of claim 15, wherein the client computing device of the third user is a near-to-eye display device having one or more sensors for detecting the eye gaze direction of the third user, wherein the first rendering depicting the first user is a first avatar representing the first user, the second rendering depicting the second user is a second avatar representing the second user.

18. The computer-readable storage medium of claim 15, wherein the computer-executable instructions further cause the one or more processing units to:
receive a first input from a first device of the first user, the first input indicating that the first user has selected a signer role;
update a meeting object with permissions for allowing the first user to the signer role, the signer role allowing the first user to be tethered to any one user with an interpreter role, other users not having the signer role is restricted from being tethered to any one user with the interpreter role;
receive a second input from a second device of the second user, the second input indicating that the second user has selected the signer role;
update the meeting object with permissions for allowing the second user to the signer role, the signer role allowing the second user to be tethered to the any one user with the interpreter role, other users not having the signer role is restricted from being tethered to any one user with the interpreter role;
receive a third input from a third device of the third user, the third input indicating that the third user has selected an interpreter role; and
update the meeting object with permissions for allowing the third user to the interpreter role, the interpreter role allowing the third user to be tethered to one or more users with the signer role, other users not having the interpreter role is restricted from being tethered to the one or more users with the signer role, wherein the permissions allowing the allowing the third user to be tethered to one or more users enables the system to function in the second operating mode and the third operating mode.

19. The computer-readable storage medium of claim 15, wherein the computer-executable instructions further cause the one or more processing units to: access permissions that persist across multiple communication sessions for the first user and the second user, the permissions define individual prerequisites for each user, the access to the permissions is automatically performed by the system without requiring a user input, where the access to the permissions invokes an automated selection of a match between the first user and the third user based on a prerequisite of the first user matching a role of the third user, wherein the role of the third user is compatible with the prerequisite, wherein the match between the first user and the third user enables the system to automatically and dynamically tether the first user and the third user, the first user and the third user being tethered if the eye gaze direction of the third user causes the target region to be positioned to meet the predetermined condition with respect to the first rendering while the first user is performing the one or more predetermined gestures.

20. The computer-readable storage medium of claim 15, wherein the computer-executable instructions further cause the one or more processing units to:
determine that the first user and the second user have permissions to be represented by the third user;
initiate the analysis to the first live stream and the second live stream in response to determining that the first user and the second user have permissions to be represented by the third user, wherein other streams of other users are not analyzed for detecting performance of the one or more predetermined gestures if users depicted in the other streams do not have permissions to be represented by the third user;
determine that the third user has permissions to represent the first user and the second user; and
initiate the analysis of the input signal generated by one or more sensors in response to determining that the third user has permissions to represent the first user and the second user, wherein the system does not analyze other input signals generated by other sensors for detecting an eye gaze direction of another user if the other users do not have permissions to represent the first user and the second user.
